(19) United States
(12) Patent Application Publication
(10) Pub. No.: US 2024/0142032 A1
(43) Pub. Date: May 2, 2024

(54) Quick-Connect Hose Fitting

(71) Applicant: Robert Bosch GmbH, Stuttgart (DE)

(72) Inventor: Benjamin Borton, Hugo, MN (US)

(21) Appl. No.: 18/381,749

(22) Filed: Oct. 19, 2023

Related U.S. Application Data
(60) Provisional application No. 63/420,908, filed on Oct. 31, 2022.

(51) Int. Cl. F16L 37/248

(52) U.S. Cl. CPC F16L 37/248; B60S 5/00

(57) ABSTRACT

A hose connector assembly suitable for fluid exchange between a vehicle and a service cart. The assembly comprises a male fitting and a female fitting. The male fitting comprises a rotating latch that can engage with latch protrusions of the female fitting during coupling. The male fitting and female fitting create a seal. In some embodiments, the male fitting comprises a spring to optimize speed of decoupling.

### TECHNICAL FIELD

This disclosure relates to fluid exchange service carts for use in automotive repair and maintenance.

### BACKGROUND

Fluid exchange service carts are utilized in automotive repair and maintenance to perform tasks related to fluid-based systems of automobiles. Carts can be used to charge fluid into an empty system, calibrate fluid volume or fluid pressure within the system, create vacuum during maintenance or other service, or diagnose operational issues within the system. Service carts may be optimized to work with different systems of the automobile, such as being configured to optimally interact with particular fluids, such as refrigerants, hydraulic fluid, transmission fluid, brake fluid, or any other fluid known to one ordinary skill in the art.

Conventional fluid exchange service carts utilize rubber hose connectors that provide a direct connection with ports of the service cart. These direct connections are secure but can be slow to assemble or disassemble. What is desired is a secure connection between the hose and the service cart that can be quickly connected and disconnected.

### SUMMARY

One aspect of this disclosure is directed to a hose connector assembly comprising a female fitting and a male fitting. The female fitting may have a receptacle port defined by a housing, a latch protrusion extending from the housing into the port, and a first conduit in fluid communication with the receptacle port. The male fitting may be coupled with the female fitting, and may comprise a hose interface defining a hose port, the hose interface configured to couple with a hose, a second conduit in fluid communication with the hose port, a seal member, a rotating latch, and a grip portion. The service interface has an interface interior and an interface exterior, the interface interior defining a service port in fluid communication with the second conduit. The seal member surrounds a portion of the interface exterior. The rotating latch is configured to interface with the latch protrusion. The grip portion configured to facilitate rotation of the rotating latch. The service interface is received by the receptacle port during coupling of the female fitting and the male fitting, and the seal member provides a fluid-tight seal with the first conduit during the coupling. The rotating latch is rotatable between a first position that is free of the latch protrusion and a second position that is retained by the latch protrusion.

Another aspect of this disclosure is directed to a male fitting for a hose connection. The male fitting comprises a hose interface defining a hose port, the hose interface configured to couple with a hose. The male fitting further comprises a conduit in fluid communication with the hose port. The male fitting further comprises a service interface having an interface interior and an interface exterior, wherein the interface interior defines a service port in fluid communication with the conduit. The male fitting further comprises a seal member surrounding a portion of the interface exterior. The male fitting further comprises a rotating latch configured to interface with a latch protrusion of a female fitting. The male fitting further comprises a grip portion configured to facilitate rotation of the rotating latch. The rotating latch is rotatable between a first position and a second position during coupling of the male fitting with the female fitting, the first position being free of the latch protrusion and the second position being retained by the latch protrusion during coupling. In some embodiments, the male fitting comprises a spring that surround the service interface exterior, wherein the spring is configured to compress during coupling of the male fitting and the female fitting.

A further aspect of this disclosure is directed to a female fitting for a hose connection. The female fitting comprises a receptacle port defined by a housing of the female fitting, the receptacle port configured to receive a male fitting during a coupling of the female fitting and the male fitting. The female fitting further comprises a latch protrusion extending from the housing into the receptacle port, a first conduit in fluid communication with the receptacle port, and a transmission port in fluid communication with the conduit. The latch protrusion is configured to engage with the male fitting during coupling. In some embodiments, the receptacle port comprises a larger diameter than the first conduit. The female fitting may be enclosed by the housing of a service cart.

The above aspects of this disclosure and other aspects will be explained in greater detail below with reference to the attached drawings.

### BRIEF DESCRIPTION OF THE DRAWINGS

FIG. 1 is an illustration of a vehicle under service using a service cart.

FIG. 2 is an illustration of a service cart.

FIG. 3 is a close-up illustration of a male and female fitting of a quick-connect hose connector.

FIG. 4 is a close-up illustration of an alternative embodiment of a male and female fitting of a quick-connect hose connector.

FIG. 5 is an illustration of a female fitting of a hose connector.

FIG. 6 is a cross-section of the female fitting of a hose connector.

FIG. 7 is a partially-exploded view of a male fitting of a hose connector.

FIG. 8 is a cross-section of a service interface of a male fitting of a hose connector.

FIG. 9 is an illustration of a male fitting of a hose connector from a first viewing perspective.

FIG. 10 is an illustration of the male fitting of FIG. 9 from a second viewing perspective.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

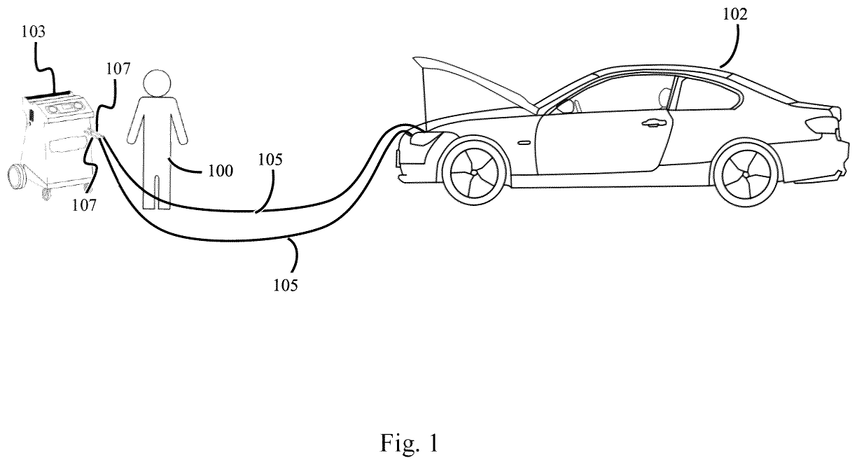

FIG. 1 depicts a typical use case of a user 100 performing a fluid exchange operation for a vehicle 102 using a service cart 103. In the depicted embodiment, the fluid exchange operation of service cart 103 is directed to the air conditioning system of vehicle 102, but other embodiments may be directed to other fluid exchange services without deviating from the teachings disclosed herein. In the depicted embodiment, refrigerant is moved between the vehicle 102 and service cart 103 via a number of hoses 105 that are coupled at one end to vehicle 102 and at the other end to service cart 103. Each of the hoses 105 are coupled to service cart 103 via a hose connector assembly 107 in an assembled state.

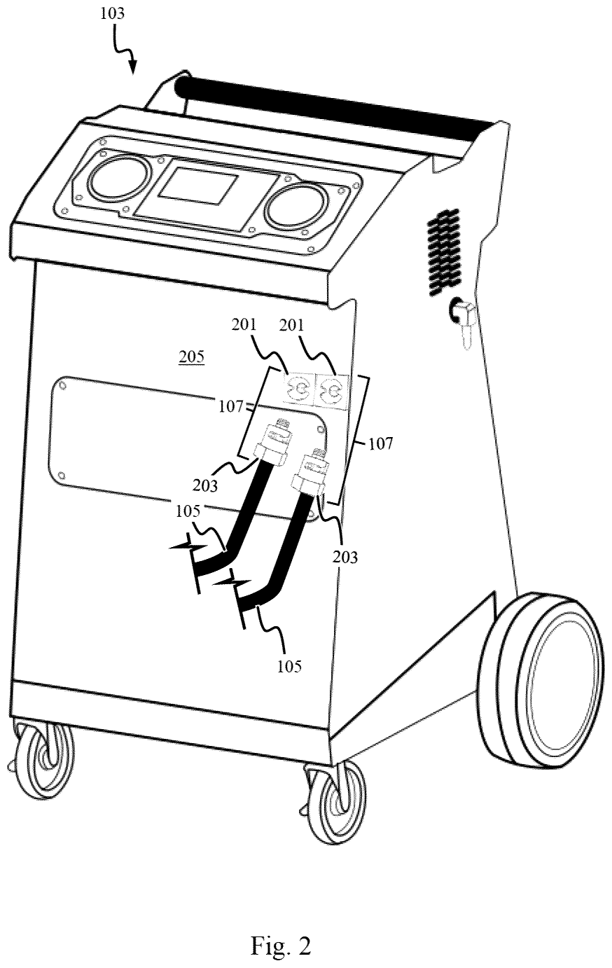

FIG. 2 depicts service cart 103 and in particular shows the components of the hose connector assembly 107 disassembled into a female fitting 201 and a male fitting 203. Advantageously, the utilization of a hose connector set that is an assembly 107 having separate female fitting 201 and male fitting 203 permits for quick connection and disconnection of hoses 105 while still retaining a fluid-tight seal. In the depicted embodiment, female fitting 201 is enclosed within the chassis 205 of service cart 103, but other embodiments may comprise other configurations without deviating from the teachings disclosed herein.

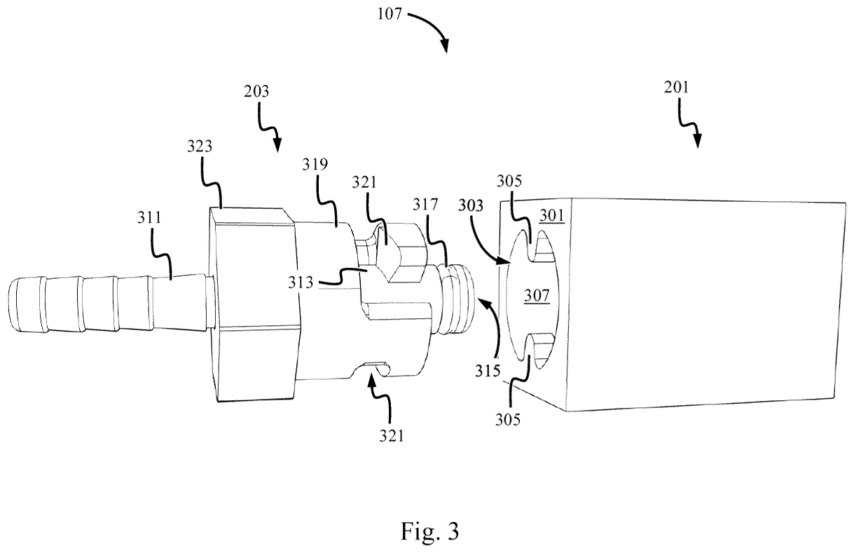

FIG. 3 provides a close-up view of the assembly 107 independently from the rest of service cart 103 (see FIG. 1: FIG. 2). As depicted in FIG. 3, assembly 107 comprises a female fitting 201 and a male fitting 203. Female fitting 203 comprises a housing 301 defining a receptacle port 303. Along the perimeter of the receptacle port 303 are a number of latch protrusions 305 extending from housing 301 into receptacle port 303. In the depicted embodiment, female fitting 203 comprises two latch protrusions 305, but other embodiments may comprise a different number without deviating from the teachings disclosed herein. In the depicted embodiment, each of the latch protrusions comprises the same shape, but other embodiments may comprise different or alternating configurations without deviating from the teachings disclosed herein. Advantageously, the depicted embodiment having latch protrusions 305 of a uniform shape permits a user to couple the female fitting 201 and the male fitting 203 without regard for a particular orientation. Other embodiments may utilize distinct shapes of the latch protrusions 305 in applications where the orientation of the coupling is critical without deviating from the teachings disclosed herein. Beyond the receptacle port 303 is a first conduit 307 which is configured to permit flow of fluid, such as refrigerant, between the male fitting 203 and the female fitting 201. Female fitting 201 comprises other features not visible in this illustration, which will be discussed in additional drawings having different perspectives.

Male fitting 203 comprises a hose interface 311 which engages with a hose (such as hose 105; see FIG. 1, FIG. 2) to create a fluid-tight seal. Hose interface 311 defines a hose port (not visible in this illustration; see FIG. 8) that permits passage of material through the male fitting 203. The fluid passes through the hose interface 311 into a service interface 313 configured to be received by the receptacle port 303 during coupling with the female fitting 201. Service interface 313 comprises an interface exterior and an interface interior portion. The interface interior defines a second conduit (not visible in this illustration: see FIG. 8) and a service port 315, through which fluid (such as refrigerant) flows between the male fitting 203 and female fitting 201 during coupling.

In order to ensure a fluid-tight connection between the fittings, male fitting 203 further comprises a seal member 317 which forms a fluid-tight seal with the first conduit of the female fitting 201 during coupling. In the depicted embodiment, seal member 317 comprises an o-ring surrounding a portion of the interface exterior, but other embodiments may comprise a different seal member without deviating from the teachings disclosed herein. Some embodiments may comprise a seal member as a component of female fitting 201 without deviating from the teachings disclosed herein.

Male fitting 203 further comprises a rotating latch 319 having a number of latch retainers 321. Rotating latch 319 is configured to freely rotate about the interface exterior of service interface 313 between a first position and a second position. In the first position, the latch retainers 321 are positioned such that they will not interfere with the coupling of male fitting 203 and female fitting 201. In this first position, the male fitting 203 may be freely inserted or removed from female fitting 201. In the second position, the latch retainers 321 will be positioned to retain the latch protrusions 305 of the female fitting 201 after coupling. In this position, the latch retainers will prevent decoupling of the male fitting 203 and female fitting 201 until the rotating latch is placed into the first position. In the depicted embodiment, latch retainers 321 comprise latching channels suitable to form a bayonet-style latch with latch protrusions 305, but other embodiments may comprise other configurations without deviating from the teachings disclosed herein. In the depicted embodiment, rotating latch 319 comprises two latch retainers 321, but other embodiments may comprise a different number without deviating from the teachings disclosed herein. In particular, for the depicted latching mechanism, it is noted that the assembly 107 optimally comprises the same number and spacing of latch protrusions 305 as latch retainers 321, but other latch mechanisms may comprise other configurations without deviating from the teachings disclosed herein.

In the depicted embodiment, rotating latch 319 is a distinct component of male fitting 203 than service interface 313, which advantageously permits rotating latch 319 to freely rotate about service interface 313. This configuration is additionally advantageous because as distinct pieces, any forces or biases that service interface 313 is subjected to during the transfer of material in either direction is not transferred to rotating latch 319, which improves the stability of the latching mechanism during operation of the service cart. Other embodiments may comprise configurations wherein the rotation latch and service interface are at least partly coupled or constructed from a single piece without deviating from the teachings disclosed herein. Other embodiments may comprise a configuration of rotating latch 319 that does not freely rotate between the two positions without deviating from the teachings disclosed herein. By way of example, and not limitation, such embodiments may comprise a screw interface between the rotating latch and the service interface, a ratchet mechanism, or a locking mechanism without deviating from the teachings disclosed herein.

Male fitting 323 additionally comprises a grip portion 323 which is configured to permit a user to rotate the rotating latch 319 between the first and second positions. In the depicted embodiment, grip portion 323 is an extension of rotating latch 319, but other embodiments may comprise configurations where the components are distinct pieces and affixed, adhered, or otherwise coupled without deviating from the teachings disclosed herein. In the depicted embodiment, grip portion 323 comprises a hand-operated nut with a knurled surface to improve a user's ability to rotate the rotating latch 319 by hand, but other embodiments may comprise other configurations without deviating from the teachings disclosed herein. Such embodiments may comprise a different surface from a knurled surface, an alternative configuration of the nut (such as a star knob), or may be configured to be gripped using a wrench or specialized tool without deviating from the teachings disclosed herein.

Male fitting 203 comprises other features not visible in this illustration, which will be discussed in additional drawings having different perspectives.

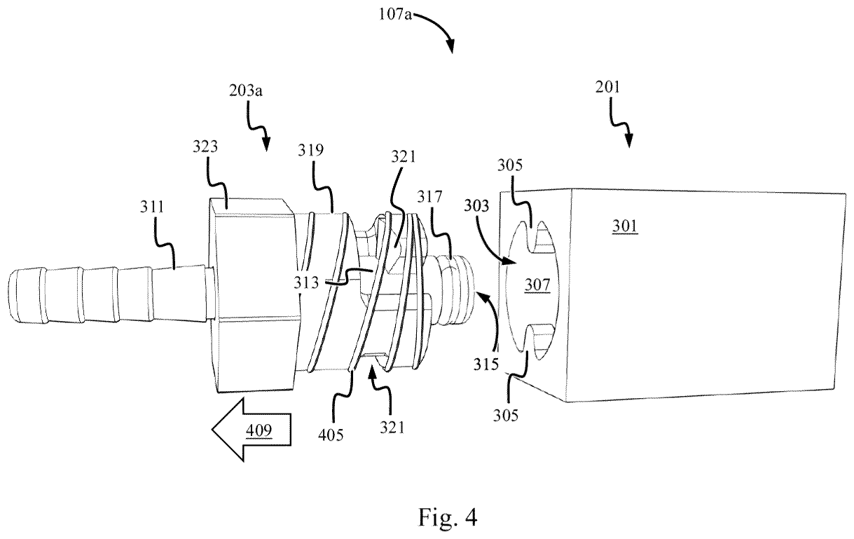

An alternative embodiment of the hose connector assembly 107 is shown in FIG. 4. This embodiment is labeled as hose connector assembly 107a. Assembly 107a comprises an identical female fitting 201, and a similar male fitting 203a. The only distinction between male fitting 203a and the male fitting 203 of FIG. 3 is the addition of a spring 405 surrounding the service interface 313. In the depicted embodiment, spring 405 additionally surrounds portions of the rotating latch 319, but other embodiments may comprise other configurations without deviating from the teachings disclosed herein. Spring 405 advantageously compresses during the coupling of male fitting 203a with female fitting 201 and provides a steady expansive force in direction 409 during coupling. This additional expansive force of spring 409 advantageously helps to secure rotating latch 319 when latch retainers 321 are engaged with latch protrusions 305. This additional security helps to ensure that the assembly 107a does not decouple except when desired by a user between service operations. In the depicted embodiment, spring 409 fits within receptacle port 303 and applies the expansive force in direction 409 against latch protrusions 305. Other embodiments may comprise other configurations without deviating from the teachings disclosed herein.

FIG. 5 is a close-up view of female fitting 201 from an alternative perspective. In this perspective, the length of the conduit 307 can be observed through receptacle port 303, and a transmission port 503 can be observed. Transmission port 503 provides an outlet for fluid passing in the assembly 107 (not depicted here; see FIG. 3, FIG. 4) between the vehicle and the service cart (see FIG. 1).

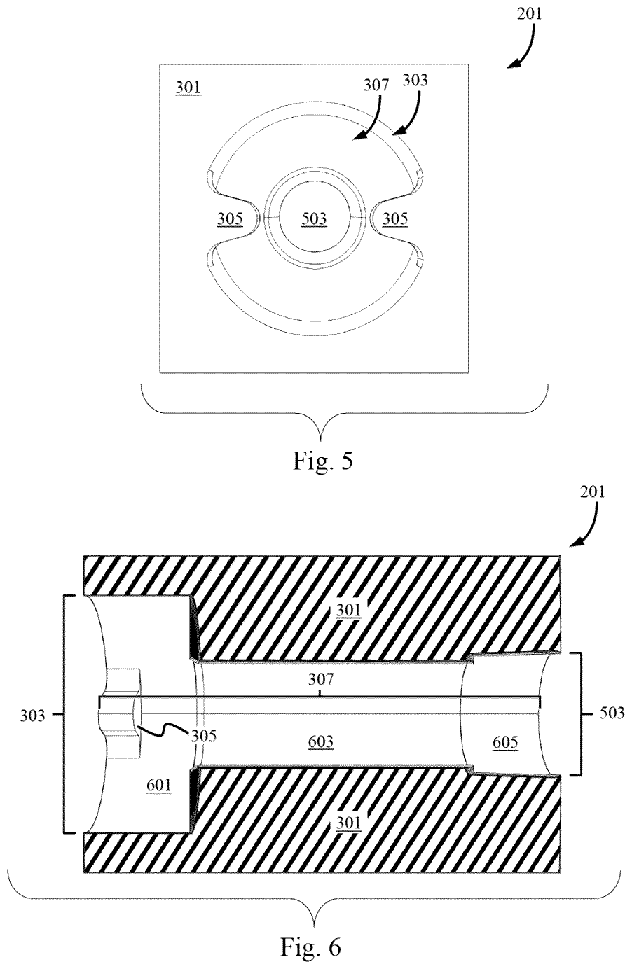

The dimensions of conduit 307 of female fitting 201 is additionally illustrated in a cross-sectional illustration of FIG. 6. FIG. 6 shows both receptacle port 303 and transmission port 503 on opposite ends of conduit 307. In the depicted embodiment, the diameter of receptacle port 303 is larger than transmission port 503, but other embodiments may comprise other configurations without deviating from the teachings disclosed herein. Conduit 307 is comprised of three sections in the depicted embodiment: a receptacle section 601, a transfer section 603, and a transmission section 605. Receptacle section 601 comprises the defined receptacle port 303 and is configured to receive the male fitting 203 (not shown: see FIG. 3, FIG. 4).

In the depicted embodiment, the depth of receptacle section 601 is sufficient to enclose a rotating latch of a corresponding male fitting (such as rotating latch 319 of male fitting 203 or 203a; see FIG. 3, FIG. 4). The depth of receptable section 601 in the depicted embodiment are also sufficient to accommodate a spring (such as spring 405; see FIG. 4) expanding against latch protrusions 305. Other embodiments may comprise other configurations of the receptacle section without deviating from the teachings disclosed herein.

In the depicted embodiment, transfer section 603 is configured to receive the service interface of a male fitting (such as service interface 313; see FIG. 3, FIG. 4). In particular, the diameter of transfer section 603 is selected in order to form a seal between the service interface and conduit 307 within transfer section 603. This seal accommodates the transfer and transmission of fluid (such as refrigerant) between the female fitting 201 and a coupled male fitting without permitting leakage or spilling of the fluid during transfer. In the depicted embodiment, transfer section 603 is configured to accommodate a seal by engaging with a sealing member (such as sealing member 317; see FIG. 3, FIG. 4), but other embodiments may comprise other configurations and create seals having different designs without deviating from the teachings disclosed herein.

In the depicted embodiment, transmission section 605 defines transmission port 503, and is the final portion of conduit 307 through which fluid (such as refrigerant) passes before entering into a different component a service cart (such as service cart 103: see FIG. 2). Transmission port 503 is configured to be coupled in a fluid-tight manner with additional components of the associated service cart, including, but not limited to, a fluid manifold, a hose, a pressure gauge, a volume meter, a flowrate sensor, or any other fluid-receiving component of a service cart known to one of ordinary skill in the art without deviating from the teachings disclosed herein.

In the depicted embodiment, all the sections of conduit 307 are constructed of a single machination within housing 301, but other embodiments may comprise other configurations without deviating from the teachings disclosed herein.

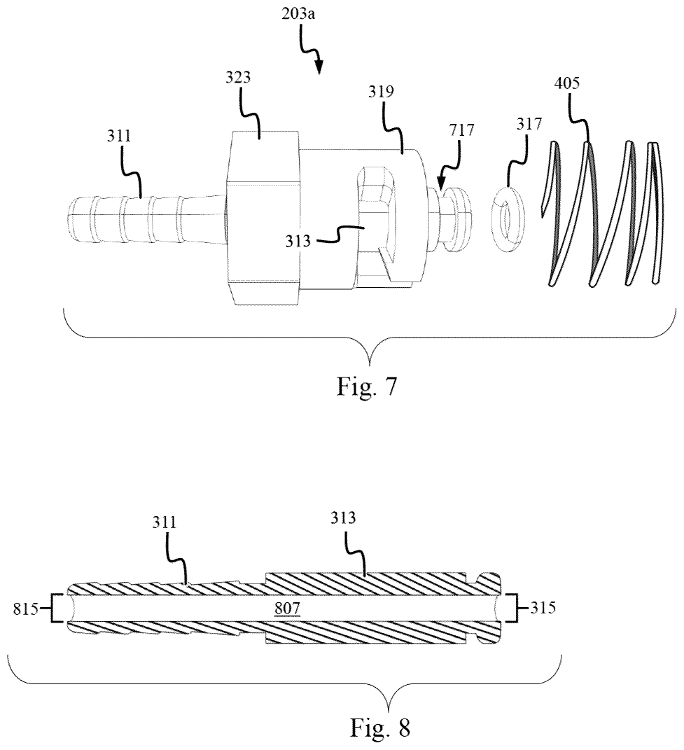

FIG. 7 is an illustration of a partially-exploded view of a male fitting 203a. Notably, the components of male fitting 203a in this view are identical to male fitting 203 (see FIG. 3), except that male fitting 203a additionally comprises a spring 405. In this depiction, the geometry of service interface 313 is shown separately from seal member 317, which better illustrates a retaining feature 717 configured to retain seal member 317. In the depicted embodiment, retaining feature 317 comprises an annular channel around the circumference of the exterior portion of service interface 313, but other embodiments may comprise other configurations without deviating from the teachings disclosed herein. The annular channel configuration of retaining feature 317 advantageously permits a more robust seal member 317 to be utilized with male fitting 203a (or male fitting 203; See FIG. 3). Other embodiments may comprise a different retaining feature 317, or may not comprise a retaining feature 317 without deviating from the teachings disclosed herein.

FIG. 8 is a cross-sectional view of hose interface 311 and service interface 313, illustrating a conduit 807 which permits fluid (such as refrigerant) to transmit from a hose through the male fitting 203 (or male fitting 203a; see FIG. 4) and into a respective female fitting (such as female fitting 201; see FIG. 3, FIG. 4). The ends of conduit 807 define ports, including the previously discussed service port 315 (see FIG. 2). Opposite of service port 315 is a hose port 815. Hose port 815 is configured to receive a fluid to or from a hose (not pictured: See FIG. 1, FIG. 2) coupled to a male fitting (such as male fitting 203 or male fitting 203a; see FIG. 3, FIG. 4) during operation of a service cart (such as service cart 103; see FIG. 1, FIG. 2).

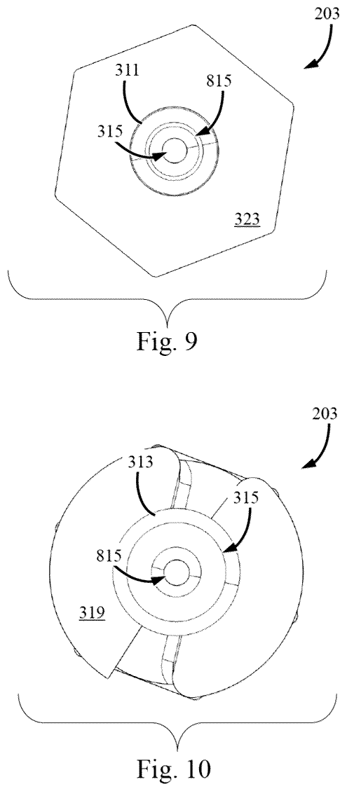

FIG. 9 and FIG. 10 provide illustrations of male fitting 203 from alternative viewpoints, with each figure providing particular perspective on the ports of the male fitting. FIG. 9 is a perspective look through the conduit 807 (see FIG. 8) from the perspective of hose port 815 in the hose interface 311. At the far end of the conduit from this perspective is interface port 315. In FIG. 9, the reverse perspective is illustrated: the view is instead looking through interface port 315 through conduit 807 (see FIG. 8) and terminating at the distal end with hose port 815.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A hose connector assembly comprising:
a female fitting having
a receptacle port defined by a housing,
a latch protrusion extending from the housing into the port,
a first conduit in fluid communication with the receptacle port; and
a male fitting coupled with the female fitting, the male fitting having
a hose interface defining a hose port, the hose interface configured to couple with a hose,
a second conduit in fluid communication with the hose port,
a service interface having an interface interior and an interface exterior, the interface interior defining a service port in fluid communication with the second conduit,
a seal member surrounding a portion of the interface exterior,
a rotating latch configured to interface with the latch protrusion, and
a grip portion configured to facilitate rotation of the rotating latch, wherein
the service interface is received by the receptacle port, wherein the seal member provides a fluid-tight seal with the first conduit, and wherein the rotating latch is rotatable between a first position that is free of the latch protrusion and a second position that is retained by the latch protrusion.

2. The hose connector assembly of claim 1, wherein the seal member comprises an o-ring.

3. The hose connector assembly of claim 2, wherein the interface exterior comprises an annular channel configured to retain the o-ring.

4. The hose connector assembly of claim 1, wherein the rotating latch comprises a groove configured to receive the latch protrusion.

5. The hose connector assembly of claim 1, wherein the male fitting further comprises a spring that surrounds the rotating latch, wherein the spring is compressed during coupling.

6. The hose connector assembly of claim 5, wherein the first conduit comprises a receiving portion and a transmission portion, the receiving portion having a larger diameter than the transmission portion, wherein the receiving portion is configured to receive the compressed spring of the male fitting.

7. The hose connector assembly of claim 1, wherein the grip portion comprises a knurled surface.

8. The hose connector assembly of claim 1, wherein the hose interface comprises a hose barb.

9. A male fitting for a hose connection comprising:
a hose interface defining a hose port, the hose interface configured to couple with a hose;
a conduit in fluid communication with the hose port;
a service interface having an interface interior and an interface exterior, the interface interior defining a service port in fluid communication with the conduit;
a seal member surrounding a portion of the interface exterior;
a rotating latch configured to interface with a latch protrusion of a female fitting; and
a grip portion configured to facilitate rotation of the rotating latch;
wherein the rotating latch is rotatable between a first position and a second position during coupling of the male fitting with the female fitting, the first position being free of the latch protrusion and the second position being retained by the latch protrusion during coupling.

10. The male fitting of claim 9, further comprising a spring that surrounds the service interface exterior, wherein the spring is configured to compress during coupling of the male fitting and the female fitting.

11. The male fitting of claim 11, wherein the spring is retained in a compressed state when the rotating latch is in the second position during coupling.

12. A female fitting for a hose connection comprising:
a receptacle port defined by a housing of the female fitting, the receptacle port configured to receive a male fitting during a coupling of the female fitting and the male fitting;
a latch protrusion extending from the housing into the receptacle port;
a first conduit in fluid communication with the receptacle port; and
a transmission port in fluid communication with the conduit.

13. The female fitting of claim 12, wherein the receptacle port comprises a larger diameter than the first conduit.

14. The female fitting of claim 12, wherein the latch protrusion is configured to engage with the male fitting during coupling.

15. The female fitting of claim 12, wherein the housing is a first housing enclosed by a second housing of a service cart.
